(19) United States
(12) Patent Application Publication
(10) Pub. No.: US 2006/0208110 A1
(43) Pub. Date: Sep. 21, 2006

(54) Connection device for hose and watering nozzle

(76) Inventor: Wen-Li Guo, Chang Hua Hsien (TW)

Correspondence Address: CHARLES E. BAXLEY, ESQ., 90 JOHN STREET, THIRD FLOOR, NEW YORK, NY, 10038, US

(21) Appl. No.: 11/202,750

(22) Filed: Aug. 12, 2005

(30) Foreign Application Priority Data
Mar. 18, 2005 (CN) 200510024489.7

(51) Int. Cl. B05B 15/08

(52) U.S. Cl. 239/587.1

(57) ABSTRACT

A hose connection device includes a handle and a first flange extends from an inner periphery of the through hole of the handle. A connection member has a axial passage and a second flange extends from an outer periphery thereof. The connection member is inserted in the through hole and the first flange is overlapped on the second flange. A nut is received in the through hole and threadedly mounted to the connection member so that the connection member is independently rotatable relative to the handle. The handle includes a connection end with outer threaded periphery for being connected with a watering nozzle.

### FIELD OF THE INVENTION

The present invention relates to a hose connection device which allows the hose and the watering nozzle to be rotated independently.

### BACKGROUND OF THE INVENTION

A conventional connection device for hose is fixed type and includes a threaded end connected to one end of the hose and the watering nozzle is threadedly connected to the threaded end. The users hold the handle of the watering nozzle to water garden. However, the hose is twisted or bent when watering the garden and water in the hose is stopped if the hose the twisted.

The present invention intends to provide a connection device for hose and watering nozzle which is rotatable independently from the hose.

### SUMMARY OF THE INVENTION

The present invention relates to a hose connection device that comprises a handle having a through hole defined axially therethrough and a first flange extends from an inner periphery of the through hole. A connection member is inserted in the handle and has a passage defined axially therethrough. A second flange extends from an outer periphery of the connection member and the first flange is overlapped on the second flange. A nut is received in the through hole and threadedly mounted to the connection member. A lower end of the nut is in contact with a top of the first flange so as to connect the connection member to the handle.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the hose connection device of the present invention;

FIG. 2 is a cross sectional view of the hose connection device of the present invention, and

FIG. 3 is a cross sectional view of another embodiment of the hose connection device of the present invention.

### DETAILED DESCRIPTION OF THE PREFERRED EMBODIMENT

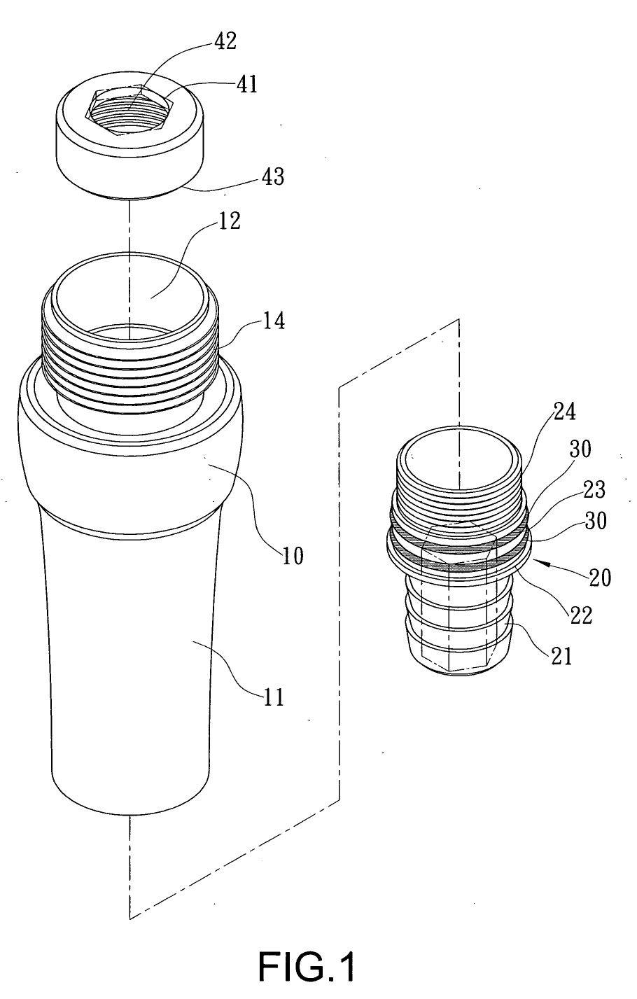

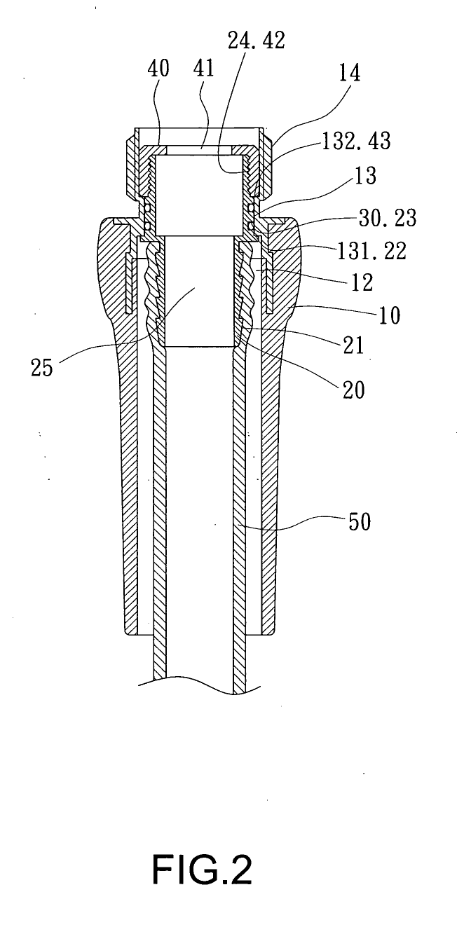

Referring to FIGS. 1 and 2, the hose connection device of the present invention comprises a handle 10 with a soft grasp portion 11 and a connection end with outer threaded periphery 14. A through hole 12 is defined axially through the handle 10 and a first flange 13 extends inward from an inner periphery of the through hole 12. A connection member 20 is received in the through hole 12 and has a passage 25 defined axially therethrough and a second flange 22 extends from an outer periphery thereof. An underside 131 of the first flange 13 is overlapped on the second flange 22 and seals 30 are engaged with grooves 23 defined in an outer periphery of the connection member 20. The connection member 20 includes a connection section 22 to which a hose 50 is connected.

A nut 40 is received in the through hole 25 and enclosed by the connection end of the handle 10, and has an inner threaded portion 42 which is engaged with an outer threaded portion 24 of the connection member 20. A lower end 43 of the nut 40 in contact with a top 132 of the first flange 13 so as to connect the connection member 20 to the handle 10. A watering nozzle (not shown) can be connected to the connection end with outer threaded periphery 14 of the handle 10. By the connection, the connection member 20 together with the hose 50 can be rotatable independently from the handle 10. The nut 40 includes a polygonal inner periphery 41 which shares a common axis with the inner threaded portion 42 of the nut 40 so that the users may use a tool to drive the nut 40 to fasten the connection member 20. The passage 25 of the connection member 20 may also include a polygonal inner periphery for engagement with a tool.

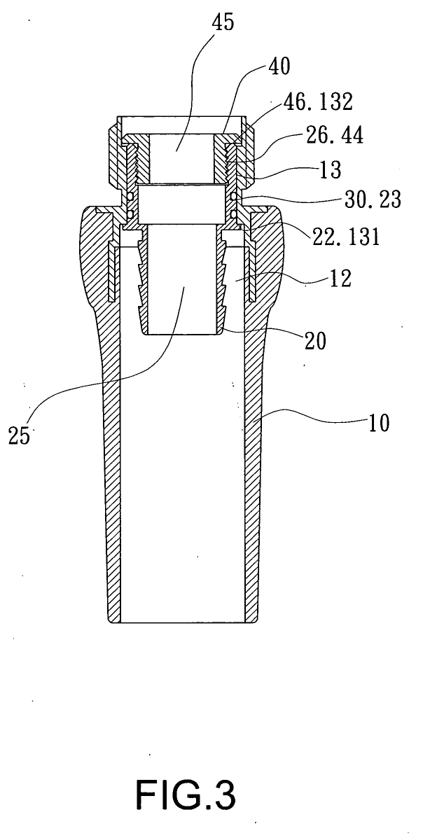

FIG. 3 shows another embodiment, wherein the connection member 20 includes an inner threaded portion 26 and the nut 40 has an outer threaded portion 44 which is engaged with the inner threaded portion 26.

While we have shown and described the embodiment in accordance with the present invention, it should be clear to those skilled in the art that further embodiments may be made without departing from the scope of the present invention.

What is claimed is:

1. A hose connection device comprising:
a handle having a through hole defined axially therethrough and a first flange extending from an inner periphery of the through hole;
a connection member having a passage defined axially therethrough and a second flange extending from an outer periphery thereof, the connection member inserted in the through hole in the handle and an underside of the first flange being overlapped on the second flange, and
a nut received in the through hole and threadedly mounted to the connection member, a lower end of the nut being in contact with a top of the first flange so as to connect the connection member to the handle.

2. The device as claimed in claim 1, wherein the handle includes a connection end with outer threaded periphery.

3. The device as claimed in claim 1, wherein the connection member includes a connection section which is adapted to be connected to a hose.

4. The device as claimed in claim 1, wherein the connection member includes an outer threaded portion and the nut has an inner threaded portion which is engaged with the outer threaded portion.

5. The device as claimed in claim 1, wherein the connection member includes an inner threaded portion and the nut has an outer threaded portion which is engaged with the inner threaded portion.

6. The device as claimed in claim 1, wherein the nut includes a polygonal inner periphery.

7. The device as claimed in claim 1, wherein the passage of the connection member includes a polygonal inner periphery.

8. The device as claimed in claim 1, wherein seals are engaged with grooves defined in an outer periphery of the connection member.
